(19) United States
(12) Patent Application Publication
(10) Pub. No.: US 2016/0259447 A1
(43) Pub. Date: Sep. 8, 2016

(54) TOUCH PANEL AND TOUCH DISPLAY PANEL

(71) Applicant: UNIDISPLAY INC., Hsinchu County (TW)

(72) Inventors: Shih-Yao Lin, Hsinchu County (TW); Ming-Tzu Tu, Taoyuan City (TW); Li-Bing Wang, Taoyuan City (TW)

(21) Appl. No.: 14/817,222

(22) Filed: Aug. 4, 2015

(30) Foreign Application Priority Data
Mar. 5, 2015 (TW) 104107009

(51) Int. Cl. G06F 3/044; G06F 3/042; G06F 3/045; G06F 3/041

(52) U.S. Cl. CPC G06F 3/044; G06F 3/0412; G06F 3/042; G06F 3/045; G06F 2203/04103; G06F 2203/04112

(57) ABSTRACT

A touch panel including a substrate and a touch sensing element is provided. The substrate has an element disposing surface. The touch sensing element is disposed on the element disposing surface and includes a plurality of first electrodes and a plurality of second electrodes electrically insulated to the first electrodes. Each of the first electrodes includes a plurality of bridge portions crossing the second electrodes. Viewing from a direction perpendicular to the element disposing surface, each of the bridge portion is configured in a curvy pattern, a zigzag pattern or combination thereof. A touch display panel is also provided.

### CROSS-REFERENCE TO RELATED APPLICATION

This application claims the priority benefit of Taiwan application serial no. 104107009, filed on Mar. 5, 2015. The entirety of the above-mentioned patent application is hereby incorporated by reference herein and made a part of this specification.

### TECHNICAL FIELD

The disclosure relates to a touch panel and a touch display panel.

### BACKGROUND

Along with the advancement of optoelectronics technology, touch panels are replacing the conventional key board or mouse as the inputting device in many electronic devices so as to attune to the demands of being compact and user-friendly. Currently, resistive touch panels and capacitve touch panels are the most common types of touch panels. For example, a capacitive touch panel is basically divided into a single layer touch sensing structure and a dual layer touch sensing structure. The dual layer touch sensing structure is typically formed with a plurlaity of first electrodes and a plurality of second electrodes. The first electrodes and the second electrodes are alternately disposed, wherein the first electrodes include a plurality of bridge portions crossing the second electrodes and the bridge portions are formed with a material with good conductivity (such as a metal). Since the reflectivity of metal is pretty high, the bridge portions are easily perceived by the user during the touch operaton, adversely affecting the visual effect of the touch panel. The current technology is mainly directed to reduce the linewidth of the bridge portions to lower the visibility of the bridge portions. However, the resistance of the bridge portions may increase with this approach and the process yield is also lower. Identifying other alternatives that can improve the visual effect of a touch panel is an object for researchers and the industry to endeavor.

### SUMMARY

An exemplary embodiment of the disclosure provides a touch panel with desirable visual effect.

An exemplary embodiment of the disclosure provides a touch display panel with desirable visual effect.

According to an exemplary embodiment of the disclosure, a touch panel includes a substrate and a touch sensing element. The substrate includes an element-disposing surface. The touch sensing element is disposed on the element-disposing surface and includes a plurality of first electrodes and a plurality of second electrodes that are electrically insulated from the first electrodes. Each of the first electrodes includes a plurality of bridge portions crossing the second electrodes. Viewing from a direction that is perpendicular to the element-disposing surface, each of the bridge portions is configured in a curvy pattern or a zigzag pattern or a combination thereof.

According to an exemplary embodiment of the disclosure, the above substrate may include a flexible substrate.

According to an exemplary embodiment of the disclosure, each of the first electrodes further includes a plurality of electrode pads, and each bridge portion serially connects two neighboring first electrode pads along a first direction. Each of the second electrodes includes a plurality of second electrode pads and a plurality of connecting portions, and each connecting portion serially connects two neighboring second electrode pads along a second direction different from the first direction. Further, each bridge portion crosses one of the connecting portions.

According to an exemplary embodiment of the disclosure, the above first electrode pads and the second electrodes belong to a same conductive layer.

According to an exemplary embodiment of the disclosure, the material of the above conductive layer includes nano silver.

According to an exemplary embodiment of the disclosure, the above touch panel further includes an insulation layer. The insulation layer covers the first electrode pads, the second electrodes and the element-disposing surface exposed by the first electrode pads and the second electrodes. The insulation layer includes a plurality of openings. Each opening respectively exposes a partial area of one of the first electrode pads, and each bridge portion serially connects two neighboring first electrode pads through corresponding openings.

According to an exemplary embodiment of the disclosure, the touch panel further includes a plurality of island-shaped insulation patterns, wherein each island-shaped pattern respectively disposed on one of the connecting portions, and each bridge portion crosses one of the island-shaped patterns to serially connect two neighboring first electrode pads.

According to an exemplary embodiment of the disclosure, the outline of each first electrode pad and each second electrode pad may be respectively configured in a curvy pattern or a zigzag pattern or a combination thereof.

According to an exemplary embodiment of the disclosure, the material of the above bridge portions includes a metal.

According to an exemplary embodiment of the disclosure, a touch display panel includes a display unit and the above disclosed touch panel, wherein the display unit and the touch sensing element are disposed on the same side of the substrate, or the display unit and the touch sensing element are respectively disposed on two opposite sides of the substrate.

According to the exemplary embodiments of the disclosure, in the touch panel and the touch display panel, the bridge portions are designed in a nonlinear pattern (not a straight-strip pattern) to minimize the visibility of the bridge portions. Accordingly, the touch panel and the touch display panels have good visual effects.

Several exemplary embodiments are described in detail below to further describe the disclosure.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1A is a partial top view of a touch panel according to an exemplary embodiment of the disclosure.

FIG. 1B is a first sectional view along the cutting line A-A′ of FIG. 1A.

FIG. 2 is a second sectional view along the cutting line A-A′ of FIG. 1A.

FIGS. 3A and 3B are partial top views of other types of bridge portions.

FIG. 4 is a partial top view of a touch panel according to another exemplary embodiment of the disclosure.

FIGS. 5 and 6 are sectional views of two touch display panels according to an exemplary embodiment of the disclosure.

### DETAILED DESCRIPTION OF DISCLOSED EXEMPLARY EMBODIMENTS

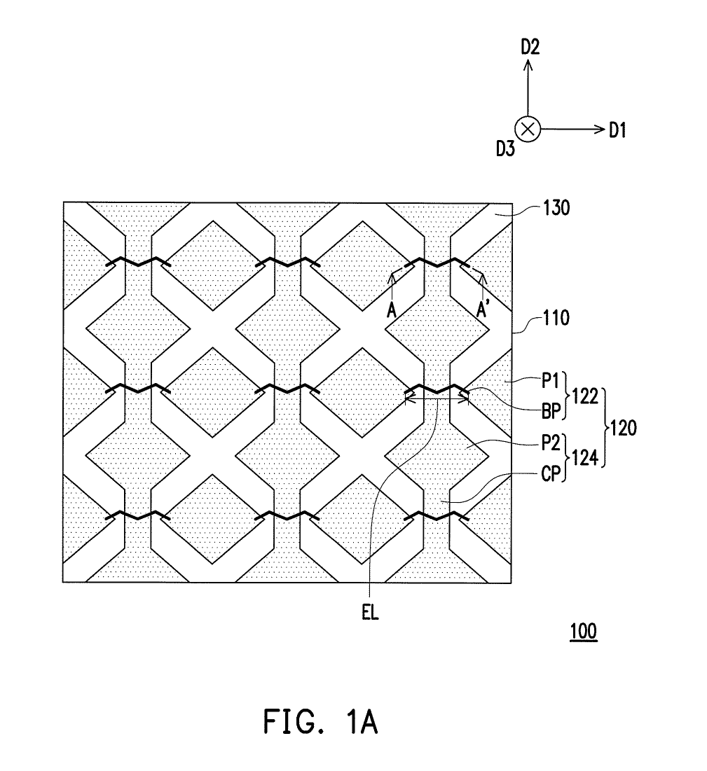

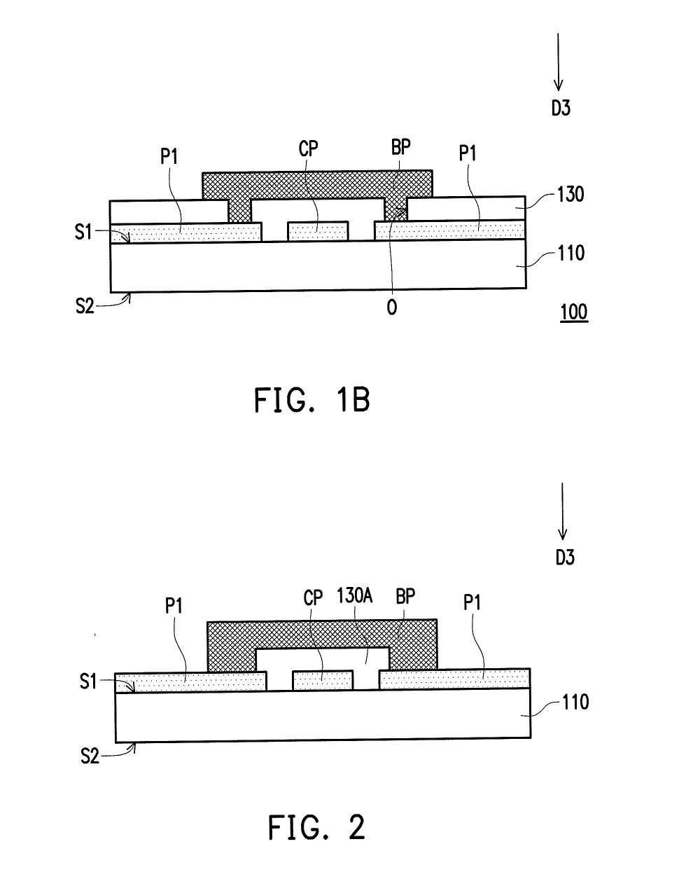

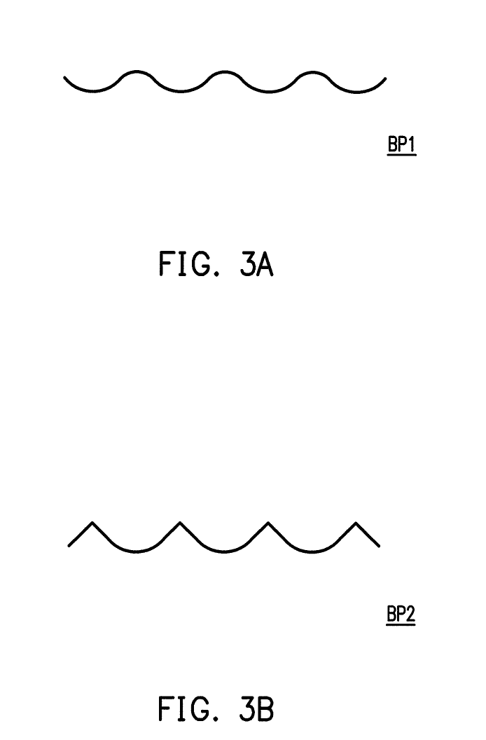

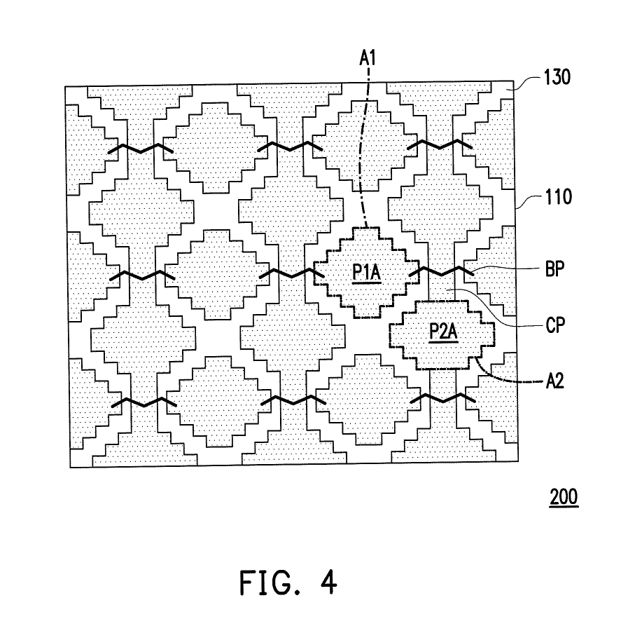

FIG. 1A is a partial top view of a touch panel according to an exemplary embodiment of the disclosure. FIG. 1B is a first sectional view along the cutting line A-A′ of FIG. 1A. FIG. 2 is a second sectional view along the cutting line A-A′ of FIG. 1A. FIGS. 3A and 3B are partial top views of other types of bridge portions. FIG. 4 is a partial top view of a touch panel according to another exemplary embodiment of the disclosure.

Referring to FIGS. 1A and 1B, the touch panel 100 of this exemplary embodiment includes a substrate 110 and a touch sensing element 120. The substrate 110 serves to carry the touch sensing element 120, which may be a device substrate in a display panel, such as an opposite substrate of a liquid crystal display panel or a package cover panel of an organic light emitting display panel. However, it should be understood that the above device substrate is presented by way of examples and not by way of limitation. Alternatively, the substrate 110 may be a cover plate independent of the display panel and used to cover or protect (such as scratch-resisting) the touch sensing element 120.

Depending on the different applications, the substrate 110 may be a hard substrate having high mechanical strength, such as a tempered glass substrate. Alternatively, the substrate 110 may be a flexible substrate with a high degree of toughness, such as a plastic substrate or a thin glass substrate, etc.

When a device applying the touch panel 100 also includes a display function or when the touch panel 100 is to be integrated with a display unit, the material of the substrate 110 may be a transparent material to avoid shielding the display light. In general, the transparent material refers to a material with high transmittance and is not necessarily limited to a material with 100% transmittance.

The substrate 110 includes an element-disposing surface S1, and the touch sensing element 120 is disposed on the element-disposing surface S1. When the substrate 110 is a cover plate, the surface S2 of the substrate 110 opposite to the element-disposing surface S1 is the operating surface. The operating surface is the surface of the substrate 110 facing the user during touch operation. Alternatively, when the substrate 110 is the device substrate in the display panel, the touch panel 100 may be further disposed with a cover plate (not shown) for protecting the touch sensing element 120. Herein, the external surface of the cover plate serves as the operating surface.

According to the different design demands, other film layers may be disposed between the touch element 120 and the element-disposing surface S1. Alternatively speaking, “the touch sensing element 120 being disposed on the element-disposing surface S1” may encompass the situations that the touch element 120 being directly disposed on the element-disposing surface S1 and the touch element 120 being indirectly disposed on the element-disposing surface S1.

The touch sensing element 120 includes a plurality of first electrodes 122 and a plurality of second electrodes 124. One of the first electrodes 122 and the second electrodes 124 may serve as driving electrodes, while another one of the first electrodes 122 and the second electrodes may serve as sensing electrodes. Using the first electrodes 122 as the driving electrodes and the second electrodes 124 as the sensing electrodes as an example, the driving signal is transmitted to the first electrodes 122 through the signal lines (not shown) and a fringe electric field is formed between the first electrodes 122 and the second electrodes 124. When a conductive object (such as a finger) touches the operating surface, the fringe electric field corresponding to the touched area changes, and the second electrodes 124 receive the changed signals and transmit the signals through the signal lines connected with the second electrodes 124 to the signal transmission circuit (not shown, such as a flexible circuit board) and then to the a control circuit (not shown), so that the touch sensing position of the conductive object is detected.

As shown in FIG. 1A, each of the first electrodes 122 includes a plurality of first electrode pads P1 and a plurality of bridge portions BR Each bridge portion BP crosses one of the second electrodes 124 to serially connect two neighboring first electrode pads P1 along a first direction D1. Each second electrode 124 includes a plurality of second electrode pads P2 and a plurality of connecting portions CP. Each connecting portion CP serially connects two neighboring second electrode pads P2 along a second directions D2, and each connecting portion CP may be crossed by only one of the bridge portions BP. In other words, the bridge portions BP and the connecting portions CP have a one-to-one relationship; however, the disclosure is not limited to the above examples. The second direction D2 is different from the first direction D1, and the second direction D2 is perpendicular to the first direction D1, for example.

The first electrode pads P1 and the second electrodes 124 may belong the same conductive layer. Alternatively speaking, the first electrode pads P1 and the second electrodes 124 may use the same conductive material and are formed in the same patterning process. Considering the overall transmittance of the touch panel 100, the material of the conductive layer may be a transparent conductive material. For example, the transparent conductive material may include, but is not limited to, nano silver. The bridge portions BP are formed subsequent to the formation of the conductive layer. Considering the signal transmission capability of the bridge portions BP, the material of the bridge portions BP may include metal.

Since the bridge portions BP and the conductive layer are formed with different materials and the reflectivity of metal is higher than that of a transparent material (such as nano silver), the bridge portions BP are easily perceived by the user when the bridge portions BP are designed in a straight-strip pattern. Accordingly, the bridge portions BP of an exemplary embodiment of the disclosure are not designed in a straight-strip pattern (a nonlinear design) and the edges of the bridge portions are blur to the viewer. Further, a nonlinear design renders the effective length EL of the bridge portions BP along the first direction D1 reduced. Therefore, according to the exemplary embodiment of the disclosure, it is not essential to reduce the length or the width of the bridge portions BP itself to curtail the visibility (obviousness) of the bridge portions BP. The touch panel 100 is provided with good visual effect without affecting the resistance of the bridge portions BP and the process yield.

It is noted that, the above bridge portions BP when being viewed from the direction D3 perpendicular to the element-disposing surface S1 adopt the nonlinear design. Further, the nonlinear design adopted by above bridge portions BP excludes only the design of the bridge portions BP being a straight-strip pattern; otherwise, the patterns of the bridge portions BP are not limited. Each bridge portion BP, aside from being designed in a zigzag pattern as shown in FIG. 1A, it can be designed in a curvy pattern, a zigzag pattern or a combination thereof. As shown in FIG. 3A, each bridge portion BP1 is designed in a curvy pattern. Alternatively, as shown in FIG. 3B, each bridge portion BP2 may be formed with multiple curvy patterns and multiple zigzag patterns, and the combination arrangement of the multiple curvy patterns and the multiple zigzag patterns is not limited to the disclosure.

Referring to FIGS. 1A and 1B again, to have the first electrodes 122 and the second electrodes 124 electrically insulated from each other, the touch panel 100 may further include an insulation layer 130. The insulation layer 130 may be a continuous insulating thin film. The insulation layer 130 covers the first electrode pads P1, the second electrodes 124 and element-disposing surface S1 exposed by the first electrode pads P1 and the second electrodes 124. Moreover, the insulation layer 130 includes a plurality of openings O. Each opening O respectively exposes a partial area of one of the first electrode pads P1 to allow each bridge portion BP to serially connect two neighboring first electrode pads P1 through corresponding openings O.

In another exemplary embodiment, as shown in FIG. 2, a plurality of island-shaped patterns 130 may be used to replace the insulation layer 130, wherein each island-shaped pattern 130A is respectively disposed on one of the connecting portions CP, and each island-shaped pattern 130A may further cover the edges of the first electrode pads P1 that are the close to the connecting portion CP. Further, each bridge portion BP crosses one of the island-shaped patterns 130A to serially connect two neighboring first electrode pads P1.

Moreover, the shape of each first electrode pads P1 and each second electrode pads P2 is not limited to the shape as illustrated in FIG. 1A. As shown in FIG. 4, when viewing from the direction D3 perpendicular to the element-disposing surface S1 (as marked in FIG. 1A), the outline A1 of each of the first electrode pads P1 and the outline A2 of each of the second electrode pads P2 is respectively configured in a curvy pattern, a zigzag pattern or a combination thereof. Alternatively, each side of each first electrode pads P1 or each second electrode pads P2 may have a serrated or saw-toothed pattern to blur the edge of the electrode pad to thereby prevent the user from identifying a sharp outline. Therefore, the visual effect of the touch panel 200 is improved. When a device including the touch panel 200 also has a display function or when the touch panel 200 is integrated with a display unit, the above design of the electrode pads can mitigate the Moiré phenomenon generated from the optical interference between the touch element and the pixel array, such that the visual quality may be improved.

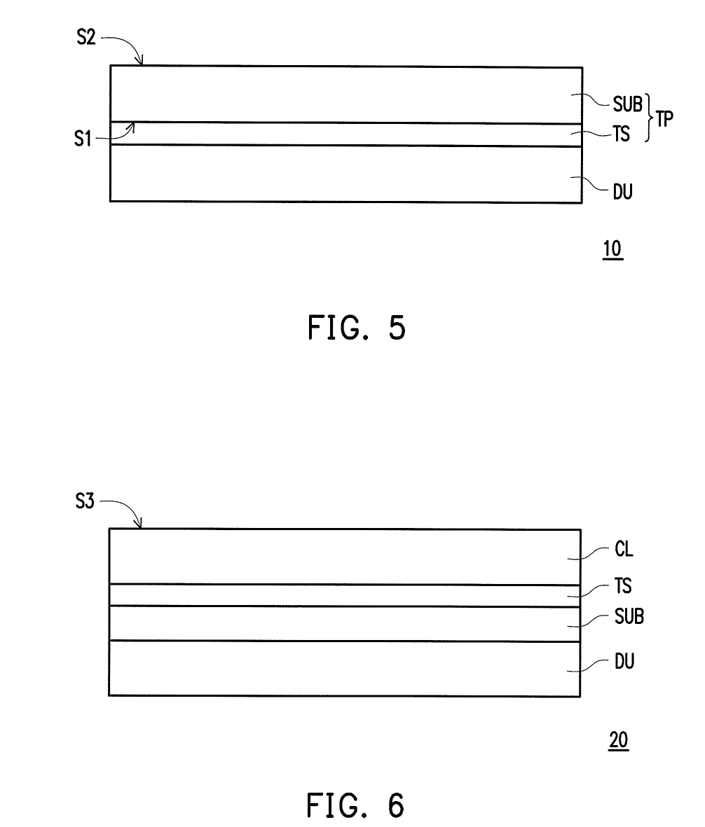

FIGS. 5 and 6 are sectional views of two touch display panels according to an exemplary embodiment of the disclosure. For the sake of simplicity, a single film layer is depicted in FIGS. 5 and 6 to represent the stacked structure of the first electrodes, the second electrodes and the insulation layer (or the insulating pattern) as shown in FIG. 1B and FIG. 2. Referring to FIG. 5, the touch display panel 10 in this exemplary embodiment includes a touch panel TP and a display unit DU. The touch panel TP may include the touch panel 100 in FIG. 1A or the touch panel 200 in FIG. 4, wherein the touch elements TS of the touch panel TP may adopt the pattern as illustrated in FIG. 1A or FIG. 4, and the bridge portions (not shown) of the touch elements TS may adopt the pattern as illustrated in FIG. 1A, 3A or 3B. In this exemplary embodiment, the substrate SUB of the touch panel TP is, for example, a cover plate, wherein the display unit DU and the touch element TS are configured at the same side of the substrate SUB, and the touch element TS is configured between the substrate SUB and the display unit DU. The surface S2 of the substrate SUB opposite to the element-disposing surface S1 is the operating surface.

In this exemplary embodiment, the display unit DU may include an active device array substrate, a display medium and a display panel opposite to the substrate. For example, the display panel may be a light crystal display panel, an organic electro-luminescence display panel, an electrophoretic display panel, a plasma display panel, an electro-wetting display panel, a field emitting display panel, or other types of display panel. Further, the touch panel TP and the display unit DU may be bonded together via an adhesive layer (not shown).

Referring to FIG. 6, the touch display panel 20 is substantially the same as the touch display panel 10, and the same reference numerals are assigned to the same or similar components and descriptions thereof are omitted. A major difference between the touch display panel 20 and the touch display panel 10 lies in that the display unit DU and the touch element TS in the touch display panel 20 are respectively configured at two opposite sides of the substrate SUB. More specifically, the substrate SUB is, for example, a device substrate of the display panel for carrying the display unit DU and the touch element TS. Alternatively speaking, the opposite substrate and the adhesive layer as shown in FIG. 5 may be omitted in the touch display panel 20 of this exemplary embodiment. Moreover, the touch display panel 20 may further include a cover plate CL for protecting the touch element TS. The touch element TS is configured between the cover plate CL and the substrate SUB, wherein the external surface S3 of the cover plate CL serves as the operating surface.

The visibility of the bridge portions in the touch display panels 10, 20 of FIGS. 5 and 6 is reduced because of the nonlinear design of the bridge portions (referring to FIGS. 1A, 3A and 3B); accordingly, the touch display panels 10, 20 have a better visual effect. Moreover, the touch element TS applies the electrode pad design as shown in FIG. 4 to not only enhance the visual effect but also concurrently mitigate the Moiré phenomenon generated from the optical interference between the touch element TS and the pixel array to further improve the visual quality of the touch display panel.

It will be apparent to those skilled in the art that various modifications and variations can be made to the structure of the disclosure without departing from the scope or spirit of the disclosure. In view of the foregoing, it is intended that the disclosure cover modifications and variations of this disclosure provided they fall within the scope of the following claims and their equivalents.

What is claimed is:

1. A touch panel, comprising:
a substrate, comprising an element-disposing surface; and
a touch sensing element, disposed on the element-disposing surface, wherein the touch sensing element comprises a plurality of first electrodes and a plurality of second electrodes that are electrically insulated from the first electrodes, and each of the first electrodes comprises a plurality of bridge portions crossing the second electrodes, and viewing from a direction perpendicular to the element-disposing surface, each of the bridge portions is configured in a curvy pattern, a zigzag pattern or a combination thereof.

2. The touch panel of claim 1, wherein the substrate is a flexible substrate.

3. The touch panel of claim 1, wherein each of the first electrodes further comprises a plurality of first electrode pads, and each of the bridge portions serially connects two neighboring first electrode pads along a first direction, each of the second electrodes comprises a plurality of second electrode pads and a plurality of connecting portions, and each of the connecting portions serially connects two neighboring second electrode pads along a second direction which is different from the first direction, and each of the bridge portions crosses one of the connecting portions.

4. The touch panel of claim 3, wherein the first electrode pads and the second electrodes belong to a same conductive layer.

5. The touch panel of claim 4, wherein a material of the conductive layer comprises nano silver.

6. The touch panel of claim 3 further comprising:
an insulation layer, covering the first electrode pads, the second electrodes and the element-disposing surface exposed by the first electrode pads and the second electrodes, and the insulation layer comprising a plurality of openings, each of the openings exposing a partial area of one of the first electrode pads, and each of the bridge portions serially connecting the two neighboring first electrode pads through corresponding openings.

7. The touch panel of claim 3 further comprising:
a plurality of island-shaped insulation patterns, wherein each of the island-shaped insulation patterns respectively configured on one of the connecting portions, and each of the bridge portions crosses one of the island-shaped insulation patterns to serially connect two neighboring first electrode pads.

8. The touch panel of claim 3, wherein an outline of each of the first electrode pads and each of the second electrode pads is respectively configured in a curvy pattern, a zigzag pattern or a combination thereof.

9. The touch panel of claim 1, wherein a material of the bridge portions comprises a metal.

10. A touch display panel comprising:. a display unit; and
a touch panel comprising:
a substrate, comprising an element-disposing surface; and
a touch sensing element, disposed on the element-disposing surface, wherein the display unit and the touch sensing element are disposed on a same side of the substrate or the touch display unit and the touch sensing element are respectively disposed at two opposite sides of the substrate, and the touch sensing element comprises a plurality of first electrodes and a plurality of second electrodes that are electrically insulated from the first electrodes, and each of the first electrodes comprises a plurality of bridge portions crossing the second electrodes, and viewing from a direction perpendicular to the element-disposing surface, each of the bridge portions is configured in a curvy pattern, a zigzag pattern or a combination thereof.

11. The touch display panel of claim 10, wherein the substrate is a flexible substrate.

12. The touch display panel of claim 10, wherein each of the first electrodes further comprises a plurality of first electrode pads, and each of the bridge portions serially connects two neighboring first electrode pads along a first direction, each of the second electrodes comprises a plurality of second electrode pads and a plurality of connecting portions, and each of the connecting portions serially connects two neighboring second electrode pads along a second direction that is different from the first direction, and each of the bridge portions crosses one of the connecting portions.

13. The touch display panel of claim 12, wherein the first electrode pads and the second electrodes belong to a same conductive layer.

14. The touch display panel of claim 13, wherein a material of the conductive layer comprises nano silver.

15. The touch display panel of claim 12, wherein the touch panel further comprises an insulation layer, the insulation layer covers the first electrode pads, the second electrodes and the element-disposing surface exposed by the first electrode pads and the second electrodes, and the insulation layer comprises a plurality of openings, each of the openings exposes a partial area of one of the first electrode pads, and each of the bridge portions serially connects two neighboring first electrode pads through corresponding openings.

16. The touch display panel of claim 12, wherein the touch panel further comprises a plurality of island-shaped insulation patterns, each of the island-shaped insulation patterns respectively configured on one of the connecting portions, and each of the bridge portions crosses one of the island-shaped insulation patterns to serially connect two neighboring first electrode pads.

17. The touch display panel of claim 12, wherein an outline of each of the first electrode pads and each of the second electrode pads is respectively configured in a curvy pattern, a zigzag pattern or a combination thereof.

18. The touch display panel of claim 10, wherein a material of the bridge portions comprises a metal.
